(19) United States
(12) Patent Application Publication
(10) Pub. No.: US 2008/0144171 A1
(43) Pub. Date: Jun. 19, 2008

(54) Optical zoom system and devices having same

(75) Inventor: Marko Eromaki, Tampere (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/640,461

(22) Filed: Dec. 15, 2006

(51) Int. Cl. G02B 23/14

(52) U.S. Cl. 359/432; 359/831

(57) ABSTRACT

An optical zoom system has two prisms to form an optical path loop for increasing the optical pathlength in a small device. The optical path loop is effectively introduced into the light path of the image sensor. The prisms are arranged such that the optical paths bounded by the internal reflecting surfaces form a rectangular loop. A reflecting module is inserted in the optical loop to direct the incoming light beam into the loop, and to direct the light beam exiting the other prism toward an image sensor for image formation. As such, a zooming lens group and a focusing lens group can be inserted into the loop to carry out the zooming and focusing functions. Both prisms are mechanically coupled to a single lead screw having a right-hand thread section and a left-hand thread section so that the prisms can be moved in opposite directions

### FIELD OF THE INVENTION

The present invention relates generally to an optical zoom system for use in an imaging device and, more specifically, to an optical zoom system for use in a small portable device, such as a mobile phone.

### BACKGROUND OF THE INVENTION

Typically there are two lens groups in an optical zoom system for carrying out the optical zoom function. One lens group is for changing the zoom factor and the other group is for focusing. These two lens groups are moved linearly along guide shafts back and forth by motors. The degree of zoom factor is largely determined by the travel distance by the lens groups. High zoom factor needs a long distance for the lens groups to move. This results in a long imaging module and a long zooming time from a wide-angle position to a telescopic position. In thin digital cameras and mobile phones, the travel distance is generally very limited and the limited travel distance may limit the zoom factors.

It is thus desirable and advantageous to provide a method and module for increasing the travel distance in a size-limiting device.

### SUMMARY OF THE INVENTION

The optical zoom system, according to the present invention, uses a plurality of reflecting surfaces to form an optical path loop in order to increase the optical pathlength in a small device, such as a thin camera and a mobile phone. The optical path loop is effectively introduced into the light path of the image sensor. In one of the embodiments, according to the present invention, two right-angle prisms are used to provide the reflecting surfaces. The hypotenuse of each of the right-angle prisms is used as entrance and exit face for the image forming light beam to enter and exit the prism. The right angle prisms are arranged such that the hypotenuses face one another and are parallel to one another so that the optical paths bounded by the internal reflecting surfaces of the two right-angle prisms form a rectangular loop. One of the optical paths between the hypotenuses is interrupted by two adjacent reflecting surfaces. One reflecting surface is used to direct the incoming light beam into the loop, toward the hypotenuse of one of the right-angle prisms. The other reflecting surface is used to direct the light beam exiting the other prism toward an image sensor for image formation. Advantageously, both the zooming lens group and the focusing lens group are disposed within the loop to carry out the zooming and focusing functions. In order to change the zoom factors, the distance between the two right-angle prisms is adjusted. Advantageously, both prisms are mechanically coupled to a single lead screw having a right-hand thread section and a left-hand thread section so that the prisms can be moved in opposite directions simultaneously. One of the lens groups can be attached to one of the prisms for movement along with that prism. With such a lead screw, a single actuator, such as a motor, can be used to change the zoom factors.

Thus, the first aspect of the present invention is an optical zoom system, comprising:

a first group of reflecting surfaces arranged to provide a first exit optical path spaced from and substantially parallel to a first entrance optical path;

a second group of reflecting surfaces arranged to provide a second exit optical path spaced from and substantially parallel to a second entrance optical path, wherein the second group is spaced from the first group by a distance and disposed in relationship to the first group such that the second entrance optical path is substantially coincident to the first exit optical path;

a plurality of optical components disposed in one or both of the first and second entrance optical paths for forming an imaging beam from a light beam encountering the first group of reflecting surfaces along the first entrance path; and

a movement mechanism coupled to at least one of the first group and the second group of reflecting surfaces for adjusting the distance.

According to one embodiment of the present invention, the first group of reflecting surfaces comprises a right-angle prism having a hypotenuse for accommodating the first entrance and exit optical paths, and wherein the second group of reflecting surfaces comprises a further right-angle prism having a hypotenuse for containing the second entrance and exit optical paths.

Alternatively, the first group of reflecting surfaces comprises a first retro-reflector device and the second group of reflecting surfaces comprises a second retro-reflector device.

The imaging beam is directed to an image sensor for forming an image on the image sensor, and the plurality of optical components comprise a first group of lenses and a second group of lenses, and wherein the first group of lenses is adapted to change a magnification of the image formed on the image sensor when the distance is adjusted, and the second group of lenses is adapted to focus the imaging beam on the image sensor in cooperation with the first group of lenses.

The movement mechanism comprises a shaft for mounting said at least one of the first group and the second group of reflecting surfaces, and an actuator operatively connected to the shaft for adjusting the distance. The shaft comprises a lead screw having a first thread portion and a different thread portion and wherein the first group of reflecting surfaces is mechanically coupled to the first thread portion and the second group of reflecting surfaces is mechanically coupled to the second thread portion such that the first group and the second group of reflecting surfaces are moved simultaneously in opposite directions by the actuator in said distance adjustment.

Furthermore, a guide shaft movably coupled to the first and second group of reflecting surfaces is used for guiding the first and second group of reflecting surfaces when the first group and the second group of reflecting surfaces are moved simultaneously in opposite directions by the actuator in said distance adjustment.

The first group of lenses is coupled to the first group of reflecting surfaces for movement along with the first group of reflecting surfaces.

According to one embodiment of the present invention, a reflecting module disposed in relationship to the first and second groups of reflecting surfaces is used for providing the light beam to the first group of the reflecting surface and for directing the imaging beam from the second group of the reflecting surface to an image sensor for image formation. The reflecting module comprises a reflecting surface for providing the light beam to the first group of the reflecting surfaces and a prism for directing the imaging beam, or a prism having a silvered surface for providing the light to the first group of the reflecting surfaces and for directing the imaging beam.

The second aspect of the present invention is a method for increasing an optical path in an imaging device comprising an image sensor. The method comprises:

disposing a first group of reflecting surfaces in relationship to and spaced from a second group of reflecting surfaces, wherein the first group is arranged to provide a first exit optical path spaced from and substantially parallel to a first entrance optical path, and the second group is arranged to provide a second exit optical path spaced from and substantially parallel to a second entrance optical path, such that the second entrance optical path is substantially coincident to the first exit optical path;

disposing a plurality of optical components in one or both of the first and second entrance optical paths for forming an imaging beam from a light beam encountering the first group of reflecting surfaces along the first entrance path;

directing the image beam to the image sensor for image formation; and

coupling a movement mechanism to at least one of the first group and the second group of reflecting surfaces for adjusting the distance.

According to one embodiment of the present invention, the plurality of optical components comprise a first group of lenses and a second group lenses, and wherein the first group of lenses is adapted to change a magnification of the image formed on the image sensor when the distance is adjusted, and the second group of lenses is adapted to focus the imaging beam on the image sensor in cooperation with the first group of lenses, said method further comprising:

disposing the first group of lenses in relationship to the second group of lenses so that when the distance is adjusted, the second group of lenses maintains a focused image on the image sensor.

According to one embodiment of the present invention, the method further comprises:

disposing a first reflecting surface in relationship to the first entrance path for providing the light beam; and

disposing a second reflecting surface in relationship to the second exit path for directing the imaging beam to the image sensor.

The third aspect of the present invention is a portable device comprising:

an image sensor; and

the optical zoom system for providing an imaging beam to the image sensor for image formation, wherein the optical zoom system comprises:

a first group of reflecting surfaces arranged to provide a first exit optical path spaced from and substantially parallel to a first entrance optical path;

a second group of reflecting surfaces arranged to provide a second exit optical path spaced from and substantially parallel to a second entrance optical path, wherein the second group is spaced from the first group by a distance and disposed in relationship to the first group such that the second entrance optical path is substantially coincident to the first exit optical path;

a plurality of optical components disposed in one or both of the first and second entrance optical paths for forming an imaging beam from a light beam encountering the first group of reflecting surfaces along the first entrance path; and

a movement mechanism coupled to at least one of the first group and the second group of reflecting surfaces for adjusting the distance.

The first group of reflecting surfaces comprises a right-angle prism having a hypotenuse for accommodating the first entrance and exit optical paths, and the second group of reflecting surfaces comprises a further right-angle prism having a hypotenuse for containing the second entrance and exit optical paths.

The portable device further comprises a reflecting module disposed in relationship to the first and second groups of reflecting surfaces for providing the light beam to the first group of the reflecting surface and for directing the imaging beam from the second group of the reflecting surface to an image sensor for image formation, wherein the reflecting module comprises a prism having a silvered surface for providing the light to the first group of the reflecting surfaces and for directing the imaging beam.

The portable device can be a mobile phone, a digital camera, a personal digital assistant, a communicator device or any portable device that is equipped with an imaging system.

The present invention will be become apparent upon reading the description taken in conjunction with FIGS. 1 to 10.

### BRIEF DESCRIPTION OF THE DRAWINGS

FIG. 1 is a schematic representation of the optical zoom system, according to one embodiment of the present invention.

FIG. 2 shows the reflecting surfaces for directing an incoming light beam into the loop and directing a light beam in the loop to the image sensor.

FIG. 3 shows a prism for use as a reflecting surface to direct the light beam to the image sensor.

FIG. 4 is a schematic representation of the optical zoom system including the movement mechanisms for moving the prisms.

FIG. 5 shows an isometric view of the optical zoom system including the movement mechanisms for moving the prisms.

FIG. 6 shows the beam deflection properties of a corner cube retro-reflector.

FIG. 7 shows a different embodiment of the present invention.

FIG. 8 is a schematic representation of a portable device having an optical zoom system, according to the present invention.

FIG. 9 is a schematic representation of an imaging device having an optical zoom system, according to the present invention.

FIG. 10 is a flowchart illustrating the basic method of increasing optical paths in a portable device, according to the present invention.

### DETAILED DESCRIPTION OF THE PRESENT INVENTION

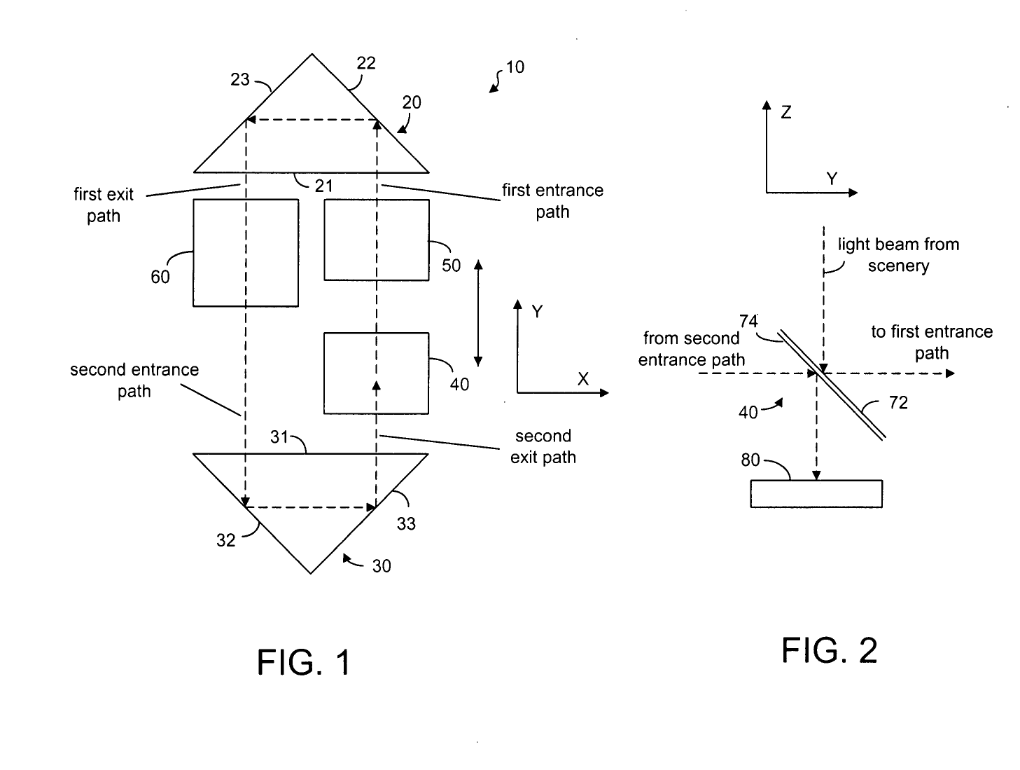

In an imaging system having an image sensor for forming an image from an incoming light beam, the present invention uses a plurality of reflecting surfaces to form an optical path loop in order to increase the optical pathlength of the incoming light beam. As such, optical components can be inserted into the loop to carry out the zooming and focusing functions of an optical zoom system. In one of the embodiments, according to the present invention, two right-angle prisms are used to provide the reflecting surfaces, as illustrated in FIGS. 1, 4 and 5.

FIG. 1 shows the arrangement of the optical components in the optical zoom system. As shown, the optical zoom system 10 comprises two right-angle prisms 20 and 30 using the hypotenuse of each prism as entrance and exit face to achieve a 180° degree deflection. The right angle prisms 20 and 30 are arranged such that their hypotenuses 21 and 31 face one another and are parallel to one another. As such, the optical paths bounded by the internal reflecting surfaces 22, 23, 32 and 33 of the two right angle prisms form a rectangular loop. One of the optical paths between the hypotenuses 21 and 31 is interrupted by two adjacent reflecting surfaces in a mirror-prism unit 40. As can be seen in FIG. 2, one reflecting surface 72 is used to direct the incoming light beam into the loop, toward the hypotenuse 21 of the right-angle prism 20. The other reflecting surface 74 is used to direct the light beam exiting the hypotenuse 31 toward an image sensor 80 for image capture. The optical zoom system 10 also comprises two lens groups: a zooming lens group 60 and the focusing lens group 50 to carry out the zooming and focusing functions. As shown in FIG. 1, the focusing lens group is disposed in one of the optical paths between the prisms 20, 30 and the zooming lens group 60 is disposed in another of the optical paths. The zoom factor of the optical zoom system 10 can be changed by adjusting the distance between the two right-angle prisms 20 and 30.

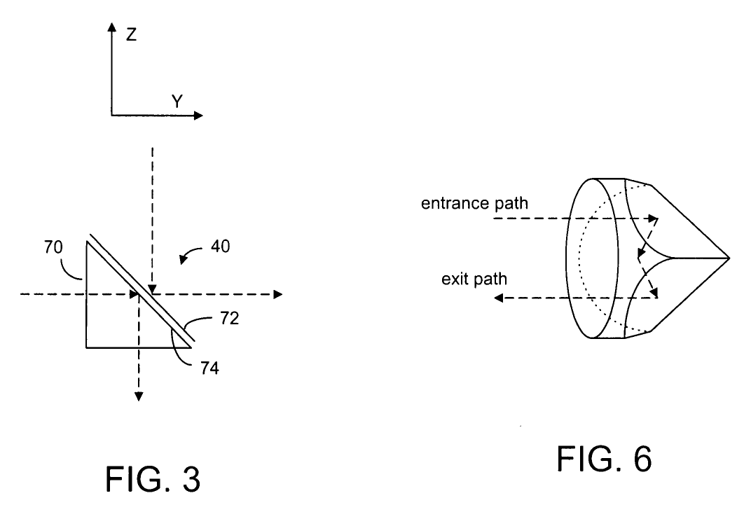

The two reflecting surfaces 72 and 74 of FIG. 2 can be realized by two mirrors, a combination of one mirror and one right-angle prism, or a single right angle prism. FIG. 3 shows a mirror-prism system 40 wherein the reflecting surface 72 is provided by a mirror while the reflecting surface 74 is achieved via the reflection at the hypotenuse of a right-angle prism 70. It is possible to use a right-angle prism with the hypotenuse silvered to provide both reflecting surfaces 72 and 74.

FIG. 4 is a schematic representation of the optical zoom system including the driving mechanisms to change the optical pathlength of the loop. As shown in FIG. 4, a lead screw 120 has two threaded sections 122 and 124 to move the prisms 20 and 30. For example, the thread on the first section 122 is right-hand type and the thread on the second section 124 is left-hand type. A nut 132 is used to carry the prism 30 and a nut 134 is used to carry the prism 20 for linear movement. A guide shaft 150 with two bushings 152 and 154 is also used to guide the prisms as the prisms are moved simultaneously in opposite directions by an actuator or motor 110. Advantageously, the focusing lens group 50 is operatively coupled to the prism 20 so that they move together. The zooming lens group 60 is moved by a separate motor 210 via a shaft 220 and a bushing 156.

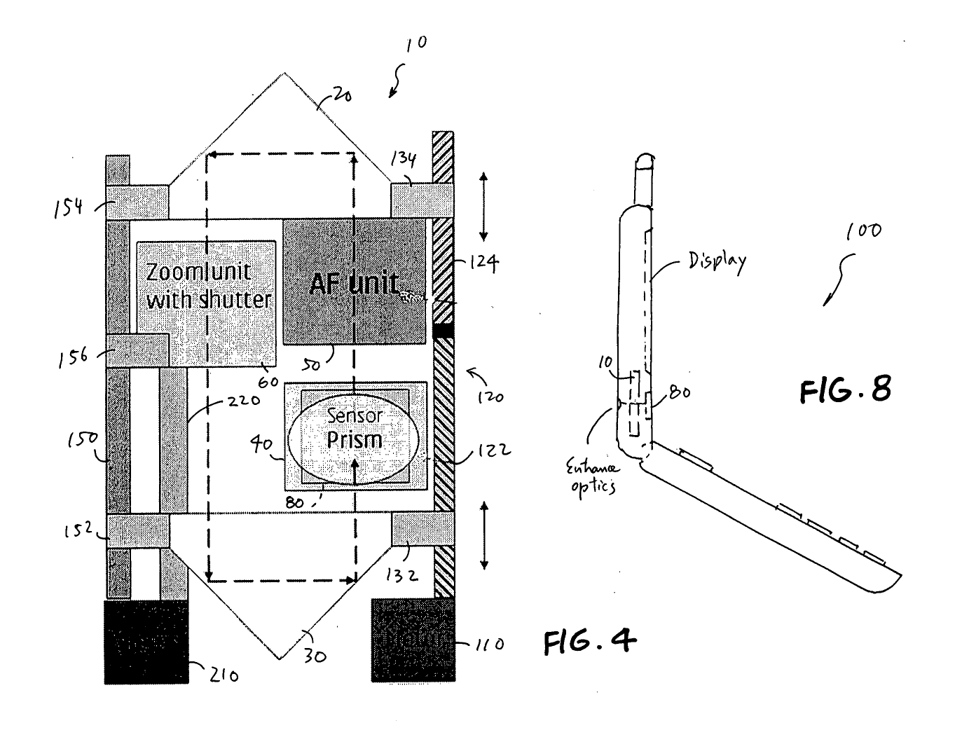

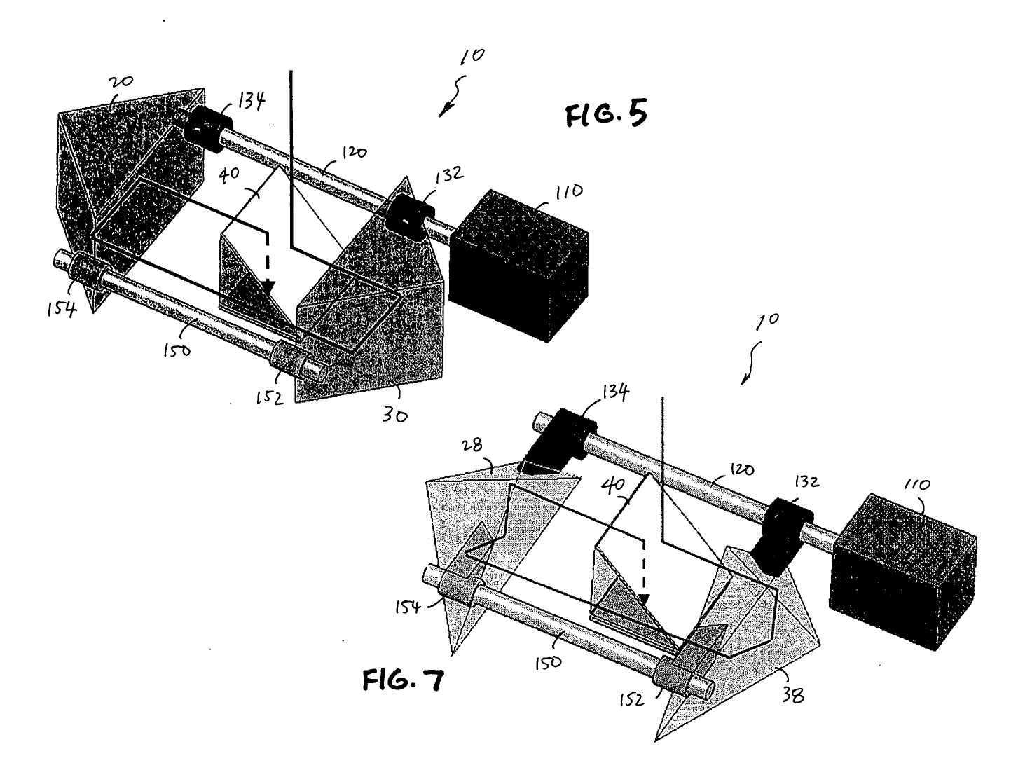

FIG. 5 is an isometric view of the optical zoom system 10, including the prisms 20 and 30, the reflecting prism 70, and the movement mechanisms. In a different embodiment, retro-reflectors such as corner-cube type prisms are used in lieu of the right-angle prisms 20 and 30. FIG. 6 shows the retro-reflection properties of a corner-cube reflecting prism. This type of prism is essentially a prism with four facets. One of the facets is used as entrance and exit face and other three facets are used as reflecting surfaces. FIG. 7 shows an optical zoom system 10 having two such four-facet prisms 28 and 38 to form an optical path loop.

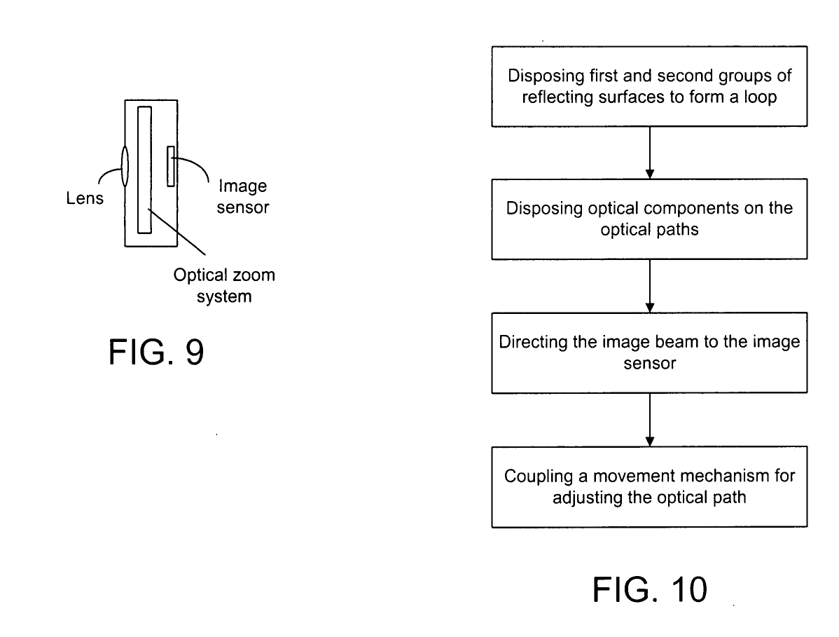

The optical zoom system 10, according to the present invention, can be implemented in a thin camera or in a small portable device, such as a mobile phone, a personal digital assistant (PDA), a communicator device or the like. FIG. 8 is a schematic representation of a portable device, such as a mobile phone 100 having an optical zoom system 10, according to one of the embodiments of the present invention. The mobile phone 100 may need a lens in front of its camera to increase the light collecting efficiency. FIG. 9 is a schematic representation of an imaging device, such as a digital camera having an optical zoom system, according to the present invention.

FIG. 10 is a flowchart illustrating the method for increasing an optical path in an imaging device comprising an image sensor. As shown in FIG. 10, the method comprises:

disposing a first group of reflecting surfaces in relationship to and spaced from a second group of reflecting surfaces, wherein the first group is arranged to provide a first exit optical path spaced from and substantially parallel to a first entrance optical path, and the second group is arranged to provide a second exit optical path spaced from and substantially parallel to a second entrance optical path, such that the second entrance optical path is substantially coincident to the first exit optical path;

disposing a plurality of optical components in one or both of the first and second entrance optical paths for forming an imaging beam from a light beam encountering the first group of reflecting surfaces along the first entrance path;

directing the image beam to the image sensor for image formation; and

coupling a movement mechanism to at least one of the first group and the second group of reflecting surfaces for adjusting the distance.

It should be noted that, as shown in FIGS. 5 and 7, the optical paths between the prism pair (20, 30) or (28, 38) lie on a plane. This plane is substantially perpendicular to the incoming beam or the z-axis. However, the entire optical zoom system can be rotated along the x-axis to a certain angle, if necessary. Thus, the plane on which the optical paths between the prism pair lie is not necessarily perpendicular to the incoming beam. Moreover, the distance between the retro-reflecting prisms that is adjusted by a lead screw and a motor such as a stepper motor or servo motor can also be adjusted by a different mechanical arrangement. Also, it is possible to use individual mirrors or a combination of mirrors and prisms to form the optical path loop in the optical zoom system, according to present invention.

Thus, although the present invention has been described with respect to one or more embodiments thereof, it will be understood by those skilled in the art that the foregoing and various other changes, omissions and deviations in the form and detail thereof may be made without departing from the scope of this invention.

What is claimed is:

1. An optical zoom system, comprising:
a first group of reflecting surfaces arranged to provide a first exit optical path spaced from and substantially parallel to a first entrance optical path;
a second group of reflecting surfaces arranged to provide a second exit optical path spaced from and substantially parallel to a second entrance optical path, wherein the second group is spaced from the first group by a distance and disposed in relationship to the first group such that the second entrance optical path is substantially coincident to the first exit optical path;
a plurality of optical components disposed in one or both of the first and second entrance optical paths for forming an imaging beam from a light beam encountering the first group of reflecting surfaces along the first entrance path; and
a movement mechanism coupled to at least one of the first group and the second group of reflecting surfaces for adjusting the distance.

2. The optical zoom system of claim 1, wherein the first group of reflecting surfaces comprises a right-angle prism having a hypotenuse for accommodating the first entrance and exit optical paths.

3. The optical zoom system of claim 2, wherein the second group of reflecting surfaces comprises a further right-angle prism having a hypotenuse for containing the second entrance and exit optical paths.

4. The optical zoom system of claim 1, wherein the first group of reflecting surfaces comprises a first retro-reflector device and the second group of reflecting surfaces comprises a second retro-reflector device.

5. The optical zoom system of claim 1, wherein the imaging beam is directed to an image sensor for forming an image on the image sensor, and the plurality of optical components comprise a first group of lenses and a second group lenses, and wherein the first group of lenses is adapted to change a magnification of the image formed on the image sensor when the distance is adjusted, and the second group of lenses is adapted to focus the imaging beam on the image sensor in cooperation with the first group of lenses.

6. The optical zoom system of claim 1, wherein the movement mechanism comprises a shaft for mounting said at least one of the first group and the second group of reflecting surfaces, and an actuator operatively connected to the shaft for adjusting the distance.

7. The optical zoom system of claim 6, wherein the shaft comprises a lead screw having a first thread portion and a different thread portion and wherein the first group of reflecting surfaces is mechanically coupled to the first thread portion and the second group of reflecting surfaces is mechanically coupled to the second thread portion such that the first group and the second group of reflecting surfaces are moved simultaneously in opposite directions by the actuator in said distance adjustment.

8. The optical zoom system of claim 7, further comprising a guide shaft movably coupled to the first and second group of reflecting surfaces for guiding the first and second group of reflecting surfaces when the first group and the second group of reflecting surfaces are moved simultaneously in opposite directions by the actuator in said distance adjustment.

9. The optical zoom system of claim 5, wherein the first group of lenses is coupled to the first group of reflecting surfaces for movement along with the first group of reflecting surfaces.

10. The optical zoom system of claim 1, further comprising a reflecting module disposed in relationship to the first and second groups of reflecting surfaces for providing the light beam to the first group of the reflecting surface and for directing the imaging beam from the second group of the reflecting surface to an image sensor for image formation.

11. The optical zoom system of claim 9, wherein the reflecting module comprises a reflecting surface for providing the light beam to the first group of the reflecting surfaces and a prism for directing the imaging beam.

12. The optical zoom system of claim 9, wherein the reflecting module comprises a prism having a silvered surface for providing the light to the first group of the reflecting surfaces and for directing the imaging beam.

13. A method for increasing an optical path in an imaging device comprising an image sensor, said method comprising:
disposing a first group of reflecting surfaces in relationship to and spaced from a second group of reflecting surfaces, wherein the first group is arranged to provide a first exit optical path spaced from and substantially parallel to a first entrance optical path, and the second group is arranged to provide a second exit optical path spaced from and substantially parallel to a second entrance optical path, such that the second entrance optical path is substantially coincident to the first exit optical path;
disposing a plurality of optical components in one or both of the first and second entrance optical paths for forming an imaging beam from a light beam encountering the first group of reflecting surfaces along the first entrance path;
directing the image beam to the image sensor for image formation; and
coupling a movement mechanism to at least one of the first group and the second group of reflecting surfaces for adjusting the distance.

14. The method of claim 13, wherein the plurality of optical components comprise a first group of lenses and a second group lenses, and wherein the first group of lenses is adapted to change a magnification of the image formed on the image sensor when the distance is adjusted, and the second group of lenses is adapted to focus the imaging beam on the image sensor in cooperation with the first group of lenses, said method further comprising:
disposing the first group of lenses in relationship to the second group of lenses so that when the distance is adjusted, the second group of lenses maintains a focused image on the image sensor.

15. The method of claim 13, further comprising:
disposing a first reflecting surface in relationship to the first entrance path for providing the light beam; and
disposing a second reflecting surface in relationship to the second exit path for directing the imaging beam to the image sensor.

16. An optical zoom system, comprising:
a first means for providing a first exit optical path spaced from and substantially parallel to a first entrance optical path;
a second means for providing a second exit optical path spaced from and substantially parallel to a second entrance optical path, wherein the second means is spaced from the first means by a distance and disposed in relationship to the first means such that the second entrance optical path is substantially coincident to the first exit optical path;
means, disposed in one or both of the first and second entrance optical paths, for forming an imaging beam from a light beam encountering the first means along the first entrance path; and
means for adjusting the distance.

17. The optical zoom system of claim 16, further comprising
means, disposed in relationship to the first means and the second means, for providing the light beam to the first means and for directing the imaging beam from the second means to an imaging forming means.

18. A portable device comprising:
an image sensor; and
the optical zoom system for providing an imaging beam to the image sensor for image formation, wherein the optical zoom system comprises:
a first group of reflecting surfaces arranged to provide a first exit optical path spaced from and substantially parallel to a first entrance optical path;
a second group of reflecting surfaces arranged to provide a second exit optical path spaced from and substantially parallel to a second entrance optical path, wherein the second group is spaced from the first group by a distance and disposed in relationship to the first group such that the second entrance optical path is substantially coincident to the first exit optical path;
a plurality of optical components disposed in one or both of the first and second entrance optical paths for forming an imaging beam from a light beam encountering the first group of reflecting surfaces along the first entrance path; and
a movement mechanism coupled to at least one of the first group and the second group of reflecting surfaces for adjusting the distance.

19. The portable device of claim 18, wherein the first group of reflecting surfaces comprises a right-angle prism having a hypotenuse for accommodating the first entrance and exit optical paths, and the second group of reflecting surfaces comprises a further right-angle prism having a hypotenuse for containing the second entrance and exit optical paths.

20. The portable device of claim 18, wherein the imaging beam is directed to an image sensor for forming an image on the image sensor, and the plurality of optical components comprise a first group of lenses and a second group lenses, and wherein the first group of lenses is adapted to change a magnification of the image formed on the image sensor when the distance is adjusted, and the second group of lenses is adapted to focus the imaging beam on the image sensor in cooperation with the first group of lenses.

21. The portable device of claim 18, further comprising a reflecting module disposed in relationship to the first and second groups of reflecting surfaces for providing the light beam to the first group of the reflecting surface and for directing the imaging beam from the second group of the reflecting surface to an image sensor for image formation, wherein the reflecting module comprises a prism having a silvered surface for providing the light to the first group of the reflecting surfaces and for directing the imaging beam.

22. The portable device of claim 18, comprising a mobile phone.

23. The portable device of claim 18, comprising a digital camera.
